(19) United States
(12) Patent Application Publication
(10) Pub. No.: US 2006/0031869 A1
(43) Pub. Date: Feb. 9, 2006

(54) Method and system for secure print-at-home discounts

(76) Inventor: David Wayne Bruner, Provo, UT (US)

Correspondence Address: Kory D. Christensen;STOEL RIVES LLP, One Utah Center, Suite 1100, 201 South Main Street, Salt Lake City, UT, 84111, US

(21) Appl. No.: 11/242,993

(22) Filed: Oct. 4, 2005

Related U.S. Application Data
(63) Continuation-in-part of application No. 10/171,505, filed on Jun. 12, 2002.
(63) Continuation-in-part of application No. 09/982,632, filed on Oct. 18, 2001.

(51) Int. Cl. H04N 7/16; G07G 1/14; H04N 7/173; G07G 1/00

(52) U.S. Cl. 725/23; 725/100; 705/14

(57) ABSTRACT

A method for increasing security in the issuance of discount coupons to consumers, the method comprising the steps of: providing printable medium to Remote Users to allow for the printing of discount offer data thereon to create negotiable discount coupons, each printable medium containing prerecorded data traceable to the Remote User to whom it was provided; exacting, recording and maintaining verifiable identification data related to each Remote User to whom the printable medium was assigned; and electronically linking at least one aspect of the identification data with the pre-printed, or pre-encoded data found on the printable medium assigned to a Remote User.

### RELATED APPLICATIONS

This application is a continuation-in-part of U.S. patent application Ser. No. 10/171,505, filed Jun. 12, 2002, for “SECURE METHOD FOR PROVIDING NEGOTIABLE DISCOUNT COUPONS TO CONSUMERS USING A DISTRIBUTED PROCESSING NETWORK.” This application is also a continuation-in-part of U.S. patent application Ser. No. 09/982,632, filed Oct. 17, 2001, for “METHOD FOR ALLOCATING NEGOTIABLE DISCOUNT COUPONS TO CONSUMERS USING A DISTRIBUTED PROCESSING NETWORK.” Both of these applications are incorporated herein by reference.

### BRIEF DESCRIPTION OF THE DRAWINGS

The embodiments disclosed herein will become more fully apparent from the following description and appended claims, taken in conjunction with the accompanying drawings. These drawings depict only typical embodiments, which will be described with additional specificity and detail through use of the accompanying drawings in which:

FIG. 1 is a block diagram of a distributed processing network;

FIG. 2 is an illustration of a sheet of a traceable printable medium, such as paper;

FIG. 3 is an illustration of a reverse side of a coupon shell and a sample of information that may be collected from a Remote User upon issuance of the traceable printable medium;

FIG. 4 is a data flow diagram associated with the distribution of the traceable, printable medium and with the third-party verification by a Program Manager for Issuing Stations desiring to verify certain Remote Users who have received issues of the traceable, printable medium;

FIG. 5 is a block diagram of a verification process to ascertain the validity of a negotiable discount coupon presented for redemption.

### DETAILED DESCRIPTION

As a brief overview, a method is provided for the secure distribution of traceable paper, or other traceable, printable medium, containing printed or embedded security codes to individuals who are positively identified, for the purpose of providing accurate electronic verification of the validity of negotiable discount coupons printed on the paper or other medium by a third party entity, on behalf of Internet discount providers, retailers, or other similarly-situated entities who have received the coupons for redemption. Printable medium is herein defined as any stock on to which data can be printed; such as, but not limited to, paper or plastic. The method may include the receipt of verifiable, unique personal data from individuals wishing to use the traceable printable medium for the printing of discounts electronically at remote terminals, and electronically linking the identity of the individuals with the security codes assigned to them. The data may then be recorded and maintained for the purpose of providing third-party verification for entities wishing to offer printable discounts and promotions to individuals to print on the traceable, printable medium. In one embodiment, the recorded data also enables the third-party entity to verify, on behalf of merchants or retailers who have received the printed discounts, that the individuals presenting the coupons for redemption are on record as having received an authorized issue of printable medium.

The method may be implemented by providing a central monitoring system utilizing at least one server system accessible via the network and operated by a third-party Program Manager. The method may include the provision of at least one Issuing Station, which offers a searchable database(s) of discount offers, authorized by participating businesses—referred to herein as Originator Stations, and one or more Remote Users having access to the searchable database(s) for the home printing of discount offers related to the purchase of various products and services. Each of the available offers may be graphically displayed on each Remote User client system as provided by the Issuing Stations. So that Remote Users will not be able to print offers as graphically displayed on their screens, the offers may be printed in different formats from those graphically displayed on the Remote Users' client systems. A Remote User's client system may be a personal computer or an Internet appliance.

The negotiable discount coupon may then be redeemed by a Remote User at a participating merchant or retailer location—defined herein as a Redemption Station—to receive the authorized discount.

As part of the method, an electronic communication will be established at different times or simultaneously between one or more Issuing Station(s) and one or more Remote User(s) and with the Program Manager server system, to allow for the printing of discount offers presented by the Issuing Station(s) to a Remote User at a Remote User station within a framework established by the Program Manager. In one embodiment, a printer is accessible to the Remote User for the authorized printing of the discount offer onto traceable paper, or other traceable, printable medium, to create a negotiable discount coupon.

The method may also require the establishment of a system for distributing traceable sheets of paper, or other traceable, printable medium, to each of the Remote Users. The traceable, printable medium, may be distributed, for example, by various merchants, banks or retailers who will verify the identity of the receiving Remote User, via a valid driver's license or other acceptable equivalent form of identification, and enter information into a system database that will associate the delivered traceable, printable medium, with the receiving Remote User; or, identification of the Remote User may be made online by the Program Manager, such that the traceable, printable medium may be mailed to the Remote User. According to one embodiment to the invention, each sheet of traceable, printable medium will include a security code individually identifying each issue of traceable, printable medium. Thus, at the time of coupon redemption, the traceable, printable medium may be linked to the receiving Remote User in order to reduce the likelihood of fraud and limit the use of and prevent the unauthorized use of discount offers.

In order to receive authorization to print discount offers and/or promotions originating from an Issuing Station database, the Remote User may be required to register the security code and/or verification code found on each package of traceable, printable medium with the Issuing Stations. The Issuing Stations' server systems may then confirm that the information previously recorded at the time of distribution of the package of traceable, printable medium corresponds to the Remote User's registration information. Upon authorization by the Program Manager's server system, the Remote User may then be allowed to print discount offers presented by the Issuing Stations, contingent on the fulfillment of any additional requirements that may be stipulated by a particular Issuing Station. In one configuration, the system creates a verification that the Remote User registering with a specific Issuing Station has received an issue of traceable, printable medium; and, that the Remote User's personal information is on record and linked with the particular issue of traceable, printable medium. The system also authenticates the flow of information between Issuing Stations, Remote User Stations, Originator Stations, and Redemption Stations, making the information more useful for marketing purposes. The accuracy of identifying information associated with a Remote User registering with a particular Issuing Station is assured, as the Remote User registration is verified with the information received from the Remote User at the time of the issue of the traceable, printable medium.

According to one embodiment of the invention, one or more sheets of traceable, printable medium are delivered to each of the participating Remote Users by the Program Manager through distribution channels heretofore disclosed, so that discount offer data may be printed thereon by the Remote User, thereby creating negotiable discount coupons. The traceable, printable medium itself may incorporate watermarks, colored fibers, polymer security thread, or pre-printed coupon formatting (also referred to as coupon shells), which may be printed with concentric fine lines, micro-printing, color-shifting ink, and/or other identifiable, but not easily duplicated features.

Additionally, multiple coupon shells may be pre-printed on each sheet of traceable, printable medium. A coupon shell is further defined as an area contained within the boundaries of the traceable, printable medium, which contains identifying marks and features for the purpose of creating a secure negotiable coupon. In addition to the features inherent in the traceable, printable medium, each coupon shell may include other prerecorded (i.e., printed or encoded) identifying features, such as bar codes, holographic stamps (similar to those placed on boxes of distributed software), two-dimensional codes, heat-sensing ink, a unique membership number and/or serial numbers, a scanable microchip, or a radio frequency identification (RFID) tag. Each of the sheets may be perforated in order to facilitate the separation of multiple coupons contained on a single sheet. Laser-cut perforations, using a special pattern, may be employed as an additional security feature.

In one implementation, each coupon shell will contain at least one pre-printed or embedded security code, which will uniquely identify each coupon shell. The security code may be a bar code, serial number, radio frequency identification or other identification device. A pre-printed security code will be printed on the back of the coupon shell to protect the code from being distorted by data printed from the Remote User's printer onto the front of the coupon shell.

The method also includes a system for verifying that a potentially negotiable coupon presented for redemption has been printed on traceable, printable medium, which has been properly assigned and recorded. A Redemption Station wishing to verify that a discount being presented for redemption has been printed on a secure issue of traceable, printable medium may either be connected with the Program Manager's computer server system with a real time connection or that the Redemption Station, on a periodic and frequent basis, synchronizes the Redemption Station's computer system with the Program Manager's server system to continually update the information related to the recorded security codes in a database managed by the Redemption Station. Alternatively, the Redemption Station may present the physical coupons to the Program Manager for subsequent verifications and recordings. The Redemption Station's computer system (POS) should be programmed to recognize the format of the security codes so that verification can be received. The recording of the printing and the redemption of discounts by Issuing Stations and by Redemption Stations provides an affective medium for monitoring the purchasing behavior of a particular individual and the effectiveness of the advertising campaigns. Since the identity of the Remote User is verifiable by the Issuing Stations due to the accurate method of identifying the Remote User at the time the traceable, printable medium is issued, profile information (such as age, gender, and place of residence) is precise and extremely valuable in any profile marketing campaign.

If any fraudulent activity is suspected by a Redemption Station concerning the use of the traceable, printable medium, the Redemption Station may contact the Program Manager concerning the potential fraud. The Program Manager may then flag, or declare invalid for future transactions, the security code related to a specific individual issue. The Program Manager may then contact all participating Issuing Stations to inform them of the need to flag, cancel, or monitor the activity of the Remote User account associated with the issue of traceable, printable medium.

Reference is now made to the Figures in which, for the purpose of clarity, the first digit of a reference numeral indicates the figure number in which the corresponding element is first used. While the various aspects of the embodiments disclosed are presented in drawings, the drawings are not necessarily drawn to scale.

In the following description, numerous specific details of programming, software modules, user selections, network transactions, database queries, database structures, and the like, are provided for a thorough understanding of various embodiments of the systems and methods disclosed herein. However, those skilled in the art will recognize that the systems and methods disclosed can be practiced without one or more of the specific details, or with other methods, components materials, and the like.

In some cases, well-known structures, materials, or operations are not shown or described in detail. Furthermore, the described features, structures, or characteristics may be combined in any suitable manner in one or more embodiments. It will also be readily understood that the components of the embodiments as generally described and illustrated in the Figures herein could be arranged and designed in a wide variety of different configurations.

The order of the steps or actions of the methods described in connection with the embodiments disclosed may be changed as would be apparent to those skilled in the art. Thus, any order in the Figures or detailed description is for illustrative purposes only and is not meant to imply a required order.

Several aspects of the embodiments described will be illustrated as software modules or components. As used herein, a software module or component may include any type of computer instruction or computer executable code located within a memory device and/or transmitted as electronic signals over a system bus or a wired or wireless network. A software module may, for instance, comprise one or more physical or logical blocks of computer instructions, which may be organized as a routine, program, object, component, data structure, and the like, that performs one or more tasks or implements particular abstract data types.

In certain embodiments, a particular software module may comprise disparate instructions stored in different locations of a memory device, which together implement the described functionality of the module. Indeed, a module may comprise a single instruction or many instructions and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices.

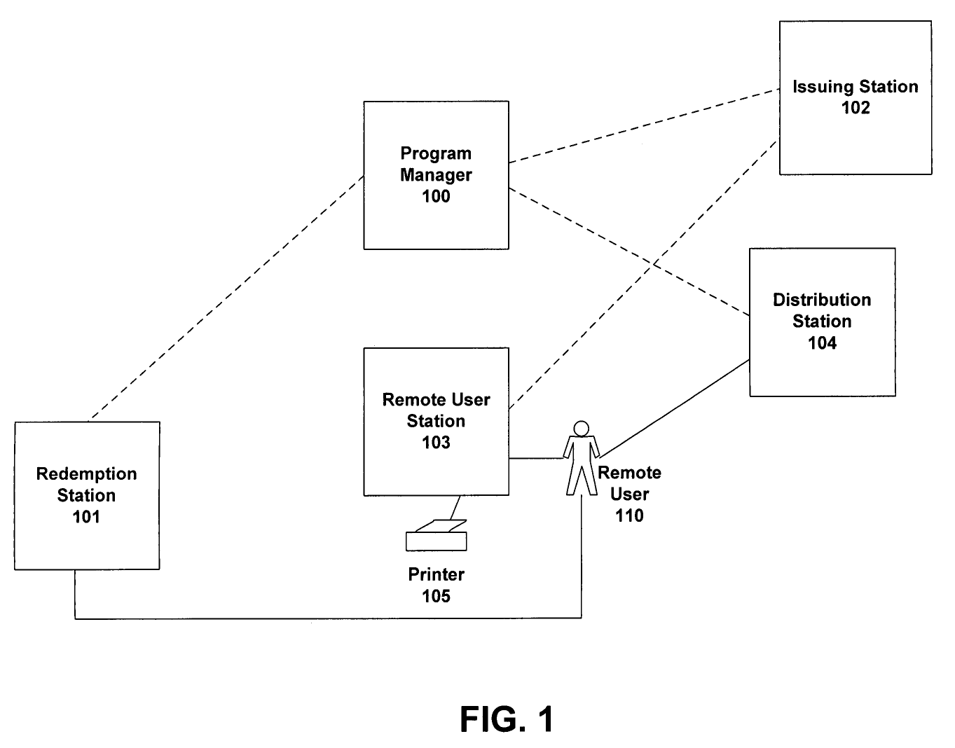

Referring now to FIG. 1, an embodiment of the invention includes the establishment of a data exchange structure, in which a Program Manager becomes the central component in monitoring, verifying, and authenticating data related to specific issues of traceable, printable medium to Remote Users for the printing of discounts thereon. The flow of data is shown over a wide-area network (WAN) through which five separate computer-related systems, controlled by multiple entities, communicate with one or more of the separate computer-related systems at different intervals, for the purpose of providing electronic-based discounts to Remote Users so that traceable negotiable discount coupons can be created and accurately monitored through redemption.

Five entities, each managing a computer-related system, and a physical representation of a Remote User, are shown for the purpose of identifying the components comprising the data exchange system. The Program Manager 100 provides a system for creating secure negotiable coupons utilizing a distributed processing network and a system for verifying and authenticating negotiable discount coupons presented for redemption at a participating Redemption Station 101

The Issuing Station 102 is a business entity, or other organization managing at least one database of discount offers and related data, which discount offers and related data may be provided to Remote Users who desire to use the offers on specified products and/or services.

The Remote User Station 103 represents a consumer utilizing a personal computer system who wishes to take advantage of discount offers and/or promotions made available by the Issuing Station 102 on products and/or services, enabling a consumer to print at home the discounts offers and/or promotions on a printer 105 accessible to the personal computer at the Remote User Station 103.

The Redemption Station 101 is a retail outlet or other merchant which sells products and/or services; for which discount offers and/or promotions have been provided to a Remote User at a Remote User Station 103 by the Issuing Station 102 for the purpose of printing on the printer 105 and presenting for redemption, negotiable discount coupons at the Redemption Station 101.

The Distribution Station 104 is a bank, retail outlet, or other similarly situated business, which collects verifiable personal data from and provides a physical issue of traceable, printable medium to a specific Remote User 110 for the purpose of printing discounts thereon.

FIG. 1 shows the Issuing Station 102 utilizing a computer server system, the Program Manager 100 utilizing a computer server system, the Remote User Station 103 utilizing a personal computer system, the Distribution Station 104 utilizing a computer server system, and the Redemption Station 101 utilizing a point-of-sale system (POS). Communication among any of the systems is shown to take place over a wide-area network (WAN). These systems are shown for descriptive purposes and are not the only system configurations available to the entities heretofore described. The Remote User Station, for example, may choose to use a wireless device, other Internet appliance, or a personal computer. Similar types of equipment choices, including servers and multiple configurations of computer systems, may be used by Distribution Stations, Issuing Stations, and/or Redemptions Stations.

FIG. 1 shows five separate entities involved in electronic communications, though the method of the invention allows for multiple processes to be controlled by single entities. For example, a Distribution Station may be a retailer, who may also be a Redemption Station. The Program Manager, by gathering verifiable data electronically and sending via U.S. mail or similar method, traceable, printable medium to Remote Users, may be the Distribution Station. The Program Manager may manage database(s) of discount offers and promotions for participating in the operational processes of an Issuing Station. Similarly, other combinations of controlling processes are also possible. The method allows for and encourages multiple participants in each operation of the invention, other than the Program Manager, including multiple Distribution Stations, multiple Issuing Stations, multiple Redemption Stations, and multiple Remote User Stations. Multiple processes controlled by single entities will likely be using local-area networks (LAN), as opposed to the wide-area network (WAN) shown in FIG. 1, to communicate among computer systems or may house all applications and processes on one single computer or server system.

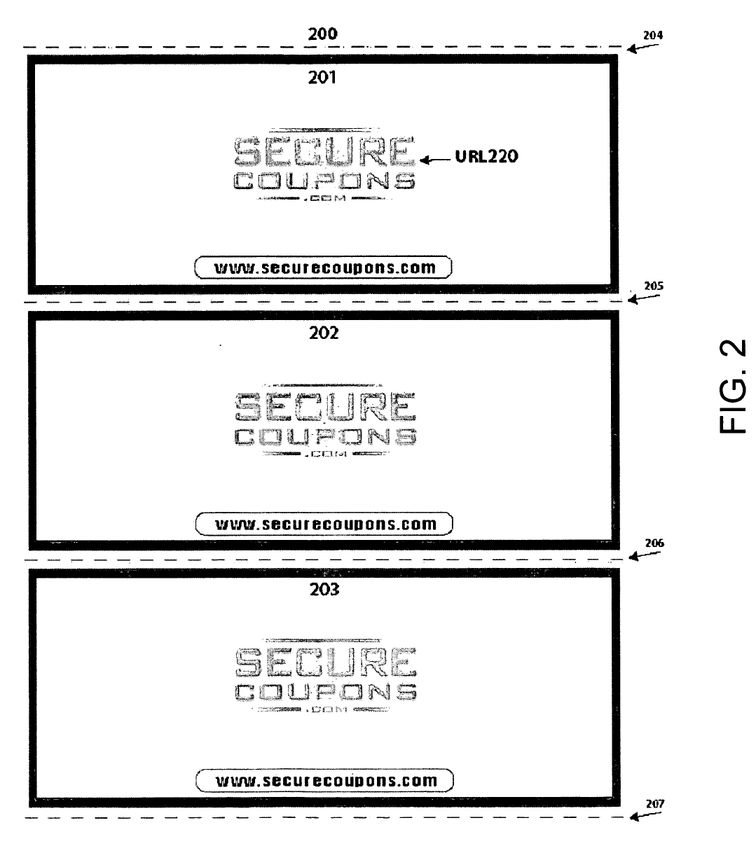

In one implementation, each Remote User is assigned a set of traceable paper, or other traceable, printable medium, which has been pre-printed or pre-encoded with a security code, in order to print discount offers and/or promotions through the system described herein. Referring now to FIG. 2, multiple sheets of traceable paper (an example of which is the sample 200) are delivered to each Remote User by the Program Manager (www.securecoupons.com, in this particular example) through, for example, a Distribution Station such as a grocery store. Each sheet of traceable paper 200 includes multiple, preprinted coupon shells—in this case, three coupon shells 201, 202, and 203. The traceable paper itself may incorporate watermarks, colored fibers, polymer security thread, or coupon formatting (also referred to as coupon shells), which may be printed, at least in part, with color-shifting ink and which may incorporate concentric fine lines, micro-printing, and/or other identifiable features which are not easily duplicated.

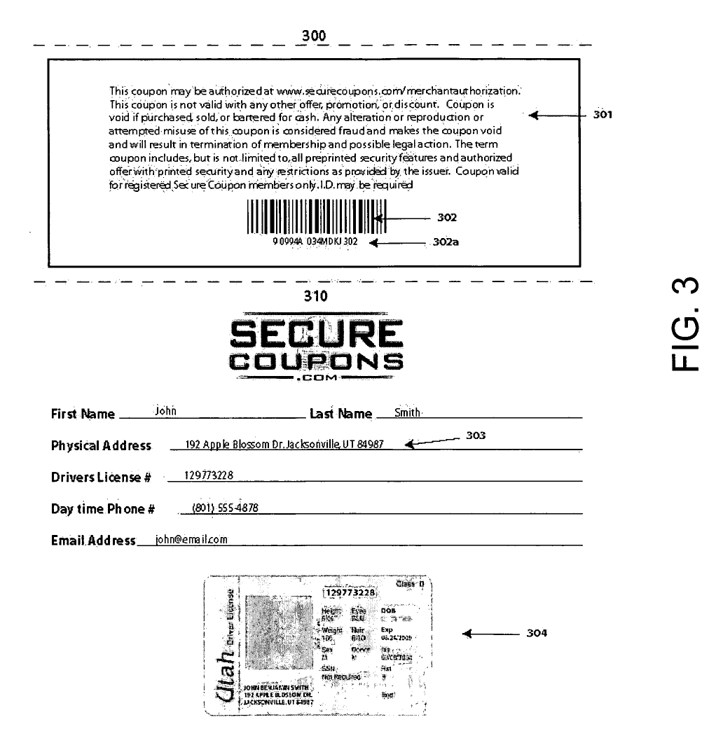

Each of the identified security features is found on currency now being printed by the United States government. Each of these features is discussed in a pamphlet entitled U.S. Currency—New Designs, published by the Federal Reserve Bank of Minneapolis, which is incorporated herein by reference. The traceable paper also includes at least one security code, which may be a bar code or other embedded code that is traceable to and which identifies, via a linking process, the receiving Remote User; and, may include other identifying features, such as holographic stamps much like those placed on boxes of distributed software, two-dimensional codes, and/or serial numbers. In one embodiment, the security code is shown in FIG. 3 as being printed on the back of a coupon shell in order to avoid any contact with Remote User printed data on the front of the coupon shell.

Still referring to FIG. 2, each of the three coupon shells 201, 202, and 203 includes tear perforations 204, 205, 206 and 207 along its outer perimeter. Not only do the perforations facilitate the separation of multiple coupons contained on a single sheet, the perforations may be designed to enhance security. For example, laser-cut perforations, using a special pattern that is recognizable to the naked eye, yet not easily duplicated, may be used. Again referring to FIG. 2, it will be noted that the coupon shell 201 bears a watermark of the Uniform Resource Locator 220 of the Program Manager company (in this case, www.securecoupons.com), as do coupon shells 202 and 203.

FIG. 3 shows a sample of the back of a coupon shell 300, including an example of rules, instructions and disclaimers 301 associated with the proper usage of the coupon shells, a pre-printed security code in the form of a barcode 302, and a matching serial number 302a. FIG. 3 also illustrates an example of the information that may be requested of a Remote User to receive an issue of traceable, printable medium 310. A Remote User may be required to provide personal information 303 and proof of identification 304 to the Program Manager, or to an agent of the Program Manager, or Distribution Station (such as a grocery store or financial institution), in order to receive an issue of traceable paper, or other traceable, printable medium. Personal information 303 and proof of identification information 304, as well as the assigned security code 302 and 302a, are uploaded by the Distribution Station into the Program Manager's server system. The Program Manager's server system maintains and links the personal information with the security code 302 and 302a assigned to the Remote User.

Any discount or promotional offers with corresponding offer data, graphics data and security data, whether authorized or unauthorized, printed on the assigned coupon shells and presented for redemption, will be traceable to the Remote User to whom the traceable paper or other traceable, printable medium was issued, creating a security neither printed nor controlled by the Remote User. The Remote User's failure to comply with the rules and instructions 301 appearing on the coupon shell may result in the coupon being rejected by a Redemption Station and an investigation of the Remote User account by the Program Manager.

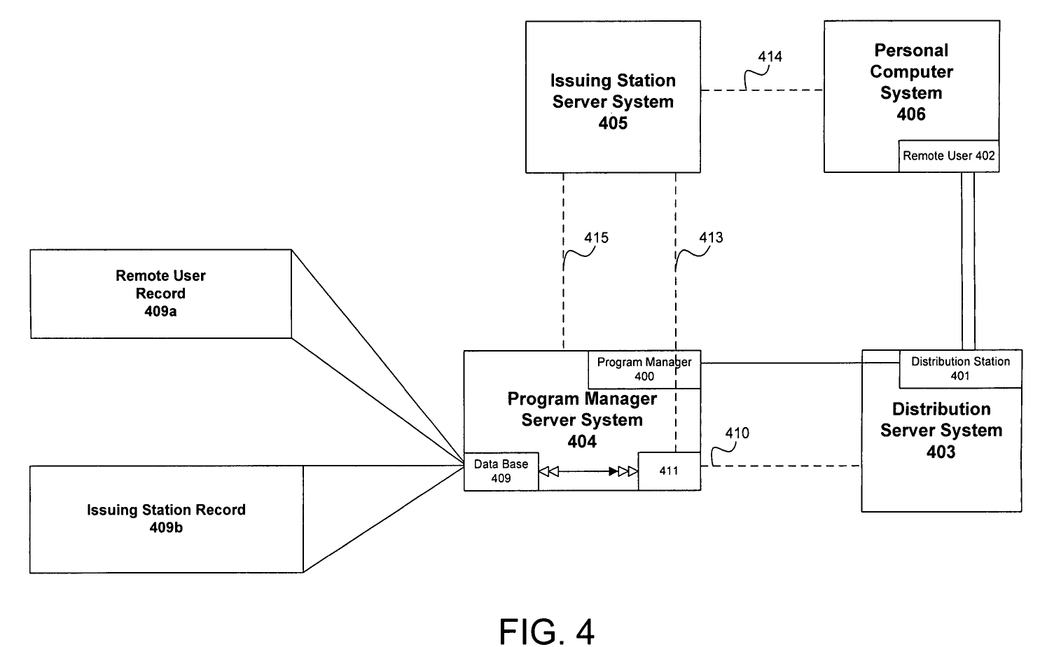

Referring to FIG. 4, a Program Manager 400 is responsible that a physical delivery of traceable, printable medium is delivered to a Distribution Station 401, such as a grocery store, for the purpose of assigning the medium to Remote Users. Alternatively, a Program Manager could assign the traceable, printable medium to Remote Users directly. The Remote User 402 physically provides personal information, such as name, physical address, e-mail address, and phone number, as well as identification information contained on an official issuance, such as a driver's license, to the Distribution Station 401. An example of this information is shown in FIG. 3. Still referring to FIG. 4, the Distribution Station 401 assigns and physically delivers a package of traceable, printable medium containing multiple sheets and multiple coupon shells, each containing a single security code, to the Remote User 402. These physical interactions that occur with the distribution of the traceable, printable medium, including the verification of identification, are the catalysts that create the high level of security on which all other processes are based.

Once the package of traceable, printable medium is distributed to the Remote User, the Distribution Station 401 utilizing a server system 403 connects electronically 410 with a web interface 411 located on the Program Manager's server system 404 and records and uploads the personal information and the Remote User identification information, in this case a driver's license, provided by the Remote User 402, with the assigned security code, to the Program Manager's server system 404, which in turn places the record in a database 409. The record containing this information is stored in 409a. The program manager now has the personal information, along with a positive identification of the Remote User to whom a package of traceable, printable medium, containing the assigned and recorded security code, was issued. Any attempts at fraud utilizing the assigned traceable, printable medium can now be traced to the Remote User to whom the traceable, printable medium was assigned. In addition, accurate information related to the Remote User can be verified and utilized for marketing purposes.

Various Issuing Stations wishing to utilize the system offered by the Program Manager will also go through an electronic registration. Still referring to FIG. 4, an Issuing Station utilizing a server system 405 will access the Program Manager's server system electronically 413 through a web interface 411. The Issuing Station will be prompted to input company identification information, which may include, but is not limited to, company name, address, contact information, phone numbers, and business license information. The Issuing Station may also be required to pay a fee for the opportunity to utilize the system offered by the Program Manager. The company identification information is then recorded and stored in a database 409 on the Program Manager's server system. The record containing this information is stored in 409b. Upon completing the registration process, the Issuing Station may then participate in the third-party verification system offered by the Program Manager.

Once the Remote User has received an issue of traceable, printable medium, the Remote User may then register with one or more Issuing Stations for the purpose of printing discount offers and/or promotions being provided by the Issuing Stations to its registered members. Referring again to FIG. 4, the Remote User 402, utilizing a personal computer system 406, electronically connects 414 with the Issuing Station's server system 405 to register. As part of the registration, the Issuing Station's server system 405 prompts the Remote User 402 to input, from the personal computer system 406, the security code found on the assigned traceable, printable medium. Utilizing a personal computer system 406, the Remote User 402, through the electronic connection 414, inputs the security code found on the issued traceable, printable medium, and the personal information given by the Remote User to the Distribution Station at the time of the issue of traceable, printable medium. Upon receiving the security code and the personal information, the Issuing Station establishes an electronic connection 415 with the Program Manager's server system 404 and sends the Remote User registration data including the security code and the Remote User personal information, to the Program Manager's server system 404, for the purpose of verifying that the security code and the personal information inputted by the Remote User match the combination of the security code and the personal information uploaded earlier by the Distribution Station to the Program Manager's server system. If the match is made, the Program Manager's server system sends, through the electronic connection 415, verification that the Remote User has received a secure issue of traceable, printable medium and that the information provided by the Remote User to the Issuing Station is validated.

For illustrative purposes, FIG. 4 shows only one Remote User, one Issuing Station, and one Distribution Station. The system is structured to include a large pool of Remote Users and encourages the participation of multiple Issuing Stations and multiple Distribution Stations—all operating within the framework shown in FIG. 4.

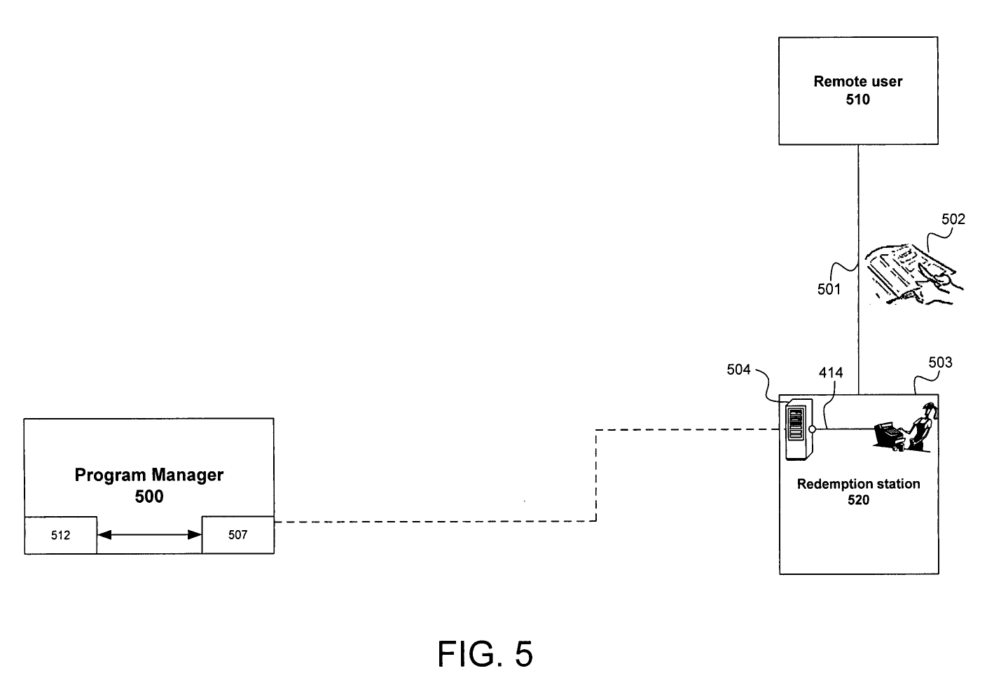

Referring to FIG. 5, the Remote User 510 makes a physical presentation 501 of a negotiable discount coupon 502 to, in this case, a cashier 503 working at a Redemption Station 520; which, for this explanation, is a grocery store. The cashier 503, after scanning the products to be purchased, receives the negotiable discount coupon 502 from the Remote User 510 and utilizing a barcode reader connected to a computer system 504, scans in the security code identifying the Remote User to whom the coupon shell was assigned. If a real-time (instantaneous) connection is available between the Redemption Station and the Program Manager 500, the Redemption Station computer system sends an electronic request for verification of the security code to the Program Manager's server processing system 507. The Program Manager's server processing system 507 queries the database 512 to verify that the security code is found and that the security code has not been flagged for possible fraudulent behavior. The Redemption Station's computer system may then accept all coupons containing the security code, assuming that no other fraudulent behavior is detected. Alternatively, for POS systems not set up to recognize the security code, the Redemption Station may present the physical coupons to the Program Manager for subsequent verifications and recordings.

Though FIG. 5 illustrates all transactions happening in real time, the system recognizes that not all Redemption Stations will have real-time connections with the Program Manager. In cases where a real-time connection does not exist, the Redemption Stations may be required to synchronize their computer systems on a frequent basis with the Program Manager's server system so that the Program Manager may provide Redemption Stations with all valid security codes associated with traceable, printable medium assigned to Remote Users.

At any time, if a coupon is improperly redeemed or presented for redemption, the Program Manager may track the coupon back to the Remote User to whom the coupon shell was issued to take any appropriate action necessary to insure that no future abuse occurs.

The Program Manager may record all verification requests from Redemption Stations to report patterns of redemption to third parties authorized to receive such information and for the purpose of collecting funds for providing security for the redemption of coupons.

While specific embodiments, applications of various methods, and systems for conducting experiments over the Internet have been illustrated and described, the invention claimed herein is not limited to the precise configuration and components disclosed. Various modifications, changes, and variations apparent to those of skill in the art may be made in the arrangement, operation, and details of the methods and systems disclosed.

Furthermore, the methods disclosed herein comprise one or more steps or actions for performing the described method. The method steps or actions may be interchanged with one another. In other words, unless a specific order of steps or actions is required for proper operation of the embodiment, the order and/or use of specific steps or actions may be modified without departing from the scope of the invention as claimed.

The embodiments disclosed may include various steps, which may be embodied in machine-executable instructions, to be executed by a general-purpose or special-purpose computer, or other electronic device. Alternatively, the steps may be performed by hardware components that contain specific logic for performing the steps or by any combination of hardware, software, and/or firmware.

Embodiments of the present invention may also be provided as a computer program product including a machine-readable medium having stored thereon instructions that may be used to program a computer or other electronic device to perform processes described herein. The machine-readable medium may include, but is not limited to, floppy diskettes, optical disks, CD-ROMs, DVD-ROMs, ROMs, RAMs, EPROMs, EEPROMs, magnetic or optical cards, propagation media, or other types of media/machine-readable medium suitable for storing electronic instructions. For example, instructions for performing described processes may be transferred from a remote computer (e.g., a server) to a requesting computer (e.g., a client) by way of data signals embodied in a carrier wave or other propagation medium via a communication link (e.g., network connection).

Those skilled in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those skilled in the art would further appreciate that the various illustrative logical blocks, modules, circuits, and algorithm steps described in connection with the embodiments disclosed herein may be implemented as electronic hardware, computer software, or combinations of both. To illustrate the interchangeability of hardware and software, various illustrative components, blocks, modules, circuits, and steps have been described above generally in terms of their functionality. Whether such functionality is implemented as hardware or software depends on the particular application and design constraints imposed on the overall system. Skilled artisans may implement the described functionality in varying ways for each particular application, but such implementation decisions should not be interpreted as causing a departure from the scope of the invention as claimed herein.

What is claimed is:

1. A method for increasing security in the issuance of discount coupons to consumers, the method comprising:
providing traceable, printable medium to remote users to allow for the printing of discount offer data thereon to create negotiable discount coupons, each printable medium containing prerecorded data traceable to the remote user to whom it was provided;
maintaining verifiable identification data related to each remote user to whom the traceable, printable medium was assigned; and
electronically linking at least one aspect of the identification data with the prerecorded data found on the traceable, printable medium assigned to a remote user.

2. The method of claim 1, wherein the traceable, printable medium is paper.

3. The method of claim 1, wherein the traceable, printable medium includes one or more coupon shells.

4. The method of claim 3, wherein each coupon shell includes at least one of the following features: a watermark, colored fibers, a holographic stamp, a two-dimensional code, printing with concentric fine lines, micro printing, and color-shifting ink.

5. The method of claim 3, wherein the coupon shell includes perforated tear lines, which facilitate the separation of the individual coupons.

6. The method of claim 1, wherein the prerecorded data is a barcode.

7. The method of claim 1, wherein the prerecorded data and the identification data of the remote user are linked in a database residing on a computer server system managed by a third-party program manager.

8. The method of claim 7, which further comprises the step of:
providing at least one issuing station that includes at least one searchable database of discount offers accessible via a distributed processing network.

9. The method of claim 8, wherein the program manager verifies security codes and personal information submitted to the at least one issuing station by remote users who desire to print discount offers found on the searchable database.

10. The method of claim 8, wherein at least one issuing station is operated by the program manager.

11. The method of claim 9, wherein the program manager provides a service for electronically verifying the authenticity of a completed coupon shell, which has been submitted for redemption at a redemption station.

12. The method of claim 1, wherein each remote user is identified by name, residence address, and an authenticating number of an official issuance.

13. The method of claim 12, wherein the official issuance includes at least one of a driver's license, a social security card and a credit card.

14. The method of claim 11, wherein the provided services are provided via the Internet.

15. A method for increasing security in the issuance of discount coupons to consumers, the method including the steps of:
providing traceable, printable medium to remote users for the printing of discount offer data thereon in order to create negotiable discount coupons, each traceable, printable medium containing at least one coupon shell containing a prerecorded security code traceable to the remote user to whom it was provided;
maintaining, in at least one database, identification data related to each remote user to whom the traceable, printable medium was provided, the at least one database providing an electronic link between at least one aspect of the identification data and the prerecorded security code;
establishing an electronic connection to at least one issuing station that includes at least one searchable database of discount offers accessible via a distributed processing network; and
providing electronic verifications to each issuing station, the verifications including assurances that:
each security code provided to an issuing station by a remote user corresponds to those in the coupon shells provided to the same remote user; and
personal information provided to an issuing station by a remote user matches at least one specific aspect of the personal information received when the printable medium was delivered to that remote user.

16. The method of claim 15, wherein the traceable, printable medium is paper.

17. The method of claim 16, wherein each coupon shell includes at least one of the following features: a watermark, colored fibers, a holographic stamp, a two-dimensional code, printing with concentric fine lines, micro printing, and color-shifting ink.

18. The method of claim 15, wherein the prerecorded security code is a barcode.

19. The method of claim 15, further comprising:
establishing a connection to at least one redemption station where discount coupons may be redeemed; and
providing electronic verifications to each redemption station of the authenticity of completed coupon shells, containing discount offer information printed thereon by remote users, which completed coupon shells are submitted for redemption.

20. The method of claim 15, wherein each remote user is identified by name, residence address, and an authenticating number of an official issuance.

21. The method of claim 15, wherein the official issuance includes at least one of a driver's license, a social security card and a credit card.

22. The method of claim 19, wherein the electronic verifications are provided via the Internet.

23. A method for increasing security in issuing discount coupons to consumers, the method comprising the steps of:
providing coupon shells to a group of remote users to enable the printing of discount offer data thereon in order to create negotiable discount coupons, each coupon shell containing a security code traceable to the subscribing consumer to whom it was provided;
maintaining identification data related to each remote user to whom the coupon shells were provided by a third-party program manager and electronically linking, in a database managed by a program manager, at least one aspect of the identification data with the prerecorded data found on the coupon shells;
establishing a connection between the program manager and at least one issuing station, an entity which provides at least one searchable database of discount offers accessible via a distributed processing network;
providing electronic verifications to each issuing station, the verifications including assurances that:
the security codes provided to an issuing station by individual remote users correspond to those on the coupon shells which have been provided to them; and
the personal information provided to an issuing station by individual remote users corresponds to at least one specific aspect of the personal information collected by the program manager when the coupon shells were provided to those remote users;
establishing a connection between a program manager and at least one redemption station where discount coupons may be redeemed; and
providing electronic verifications to the at least one redemption station of the authenticity of completed coupon shells containing discount offer information printed thereon by remote users, which are submitted for redemption.

24. A system for increasing security in the issuance of discount coupons to consumers, the system comprising:
means for providing printable medium to remote users to allow for the printing of discount offer data thereon to create negotiable discount coupons, each printable medium containing prerecorded data traceable to the remote user to whom it was provided;
means for maintaining verifiable identification data related to each remote user to whom the printable medium was assigned; and
means for electronically linking at least one aspect of the identification data with the prerecorded data found on the printable medium assigned to a remote user.
